(19) United States
(12) Patent Application Publication
(10) Pub. No.: US 2007/0174730 A1
(43) Pub. Date: Jul. 26, 2007

(54) Electronic Device and Method For Retrieving Data From a PCI Bus

(76) Inventor: Shane Tolmie, Christchurch (NZ)

Correspondence Address: LOUIS VENTRE, JR, 2483 OAKTON HILLS DRIVE, OAKTON, VA, 22124-1530, US

(21) Appl. No.: 11/625,332

(22) Filed: Jan. 21, 2007

(30) Foreign Application Priority Data
Jan. 24, 2006 (NZ) 544900

(51) Int. Cl. G06F 11/00

(52) U.S. Cl. 714/45

(57) ABSTRACT

A device and method are disclosed for monitoring and recording keystrokes and other activity on a computer. The preferred embodiment is a passive computer PCI expansion board (1) that has pins for engaging in a PCI slot on a motherboard; an electronic circuit capable of receiving, filtering, translating, and controlling storage of data visible to the data bus and received through the pins; and, memory (15) for storing the translated data. In the method of using the PCI expansion board (1), data is received in the electronic circuit through the pins of the expansion board. The electronic circuit filters the data received and selects data that can be translated to human-readable format, translates the selected data into human-readable format, and stores the data in memory (15) on the expansion board.

### CROSS-REFERENCE TO RELATED APPLICATIONS

This application is derived from, and claims the benefit of, New Zealand provisional patent application 544900, filed on Jan. 24, 2006, which is hereby incorporated by reference.

### FIELD OF INVENTION

In the field of computer security, a device and method for monitoring and recording keystrokes and other activity on a computer.

### DESCRIPTION OF PRIOR ART

The vast majority of personal computers (PC) have an internal “Peripheral Connection Interface,” or “PCI bus,” located on the motherboard of the computer. A bus is a channel or path interconnecting components to the computer's processor, also known as a central processing unit.

The PCI bus provides the means for the preferred embodiment of the invention to monitor events occurring in the computer. It is the inherent capabilities of the PCI bus that enable the device to perform its monitoring function.

The PCI bus is accessed by inserting an expansion board, also known as an expansion card or just a card, into one or more slots or plugs permanently attached to the motherboard. Inserting an expansion board into a slot for the PCI bus is also the main method for adding internal hardware and upgrading the capabilities of the computer. For example, if a user who wished to browse the Internet, the user could plug in a PCI modem card into the PCI bus, which would provide Internet connectivity.

The PCI bus enables the expansion card, that is the passive PCI expansion board of preferred embodiment of the invention, to monitor events on any external PCI card plugged into the PCI bus, as well as events that happen internally in the computer motherboard. For example, every time a key is pressed on a laptop keyboard, such keypress is electrically reflected on address 0x00000060 hex on the Mini-PCI bus inside the laptop. This means the passive PCI expansion board can listen to keys pressed on the laptop keyboard, and store them for later examination. Using the same method, the device can monitor RS232 data on the internal RS232 serial port built into the motherboard, can listen to the internal RTC (Real Time Clock) built into the motherboard, and can listen to printer data sent out of the internal parallel printer port built into the motherboard.

Two general approaches exist for PC monitoring, namely a software based approach; and a hardware based approach. The advantages of software based products are that they are easily monitored over an existing network, are unobtrusive and centralized administration is simple. The disadvantages of software-based products are that actions are not recorded before the operating system is loaded, that it is possible to disable or remove the software, to date they can not be installed on non-standard operating systems, and that they are difficult to install without computer administrator passwords or login details. The present invention does not use the software-based approach, but rather is a hardware-based approach.

U.S. Pat. No. 6,292,878 to Morioka, et al. is for a data recorder which chronologically records continuous data and which stores the procedure of recording or reproducing in the data recorder as a software program. It has application in recording continuous analogue signals such as image, etc. that are digitized and a data stream. The Morioka invention uses a software approach and is not a single expansion card, but rather has multiple complex adapters and hardware components, including a data recorder equipped with a group of recording units, and each group unit has a SCSI adaptor and a hard disk. Morioka does not teach a means to monitor and record computer activity using a single PCI card.

Some advantages of hardware-based approach are that can be run independently of operating systems, and if the operating system crashes the data in a hardware based recorder is still intact. The disadvantages of existing hardware based products are that the recording device is often easily detected and it can be disabled or removed, and that existing products can only be installed externally. Advantages of the present invention are that it is a single integrated unit in the form of an PCI expansion board that can be easily installed inside the computer where it is less likely to be detected.

Accordingly, the present invention will serve to improve the prior art by providing a hardware-based approach to computer monitoring and recording of computer activity using a single PCI expansion board that is much more easily concealed from a computer operator and that is impossible to disable by circumventing operational software.

### BRIEF SUMMARY OF THE INVENTION

A device and method are disclosed for monitoring and recording keystrokes and other activity on a computer. The preferred embodiment is a passive computer PCI expansion board that has pins for engaging in a PCI slot on a motherboard; an electronic circuit capable of receiving, filtering, translating, and controlling storage of data visible to the data bus and received through the pins; and, memory for storing the translated data. In the method of using the PCI expansion board, data is received in the electronic circuit through the pins of the expansion board. The electronic circuit filters the data received and selects data that can be translated to human-readable format, translates the selected data into human-readable format, and stores the data in memory on the expansion board.

### BRIEF DESCRIPTION OF THE DRAWINGS

Referring now to the drawings in which like reference numbers represent corresponding parts:

FIG. 1 is a block diagram of the expansion board of the preferred embodiment of the invention.

FIG. 2 is a block diagram of data handling steps used by the PCI analysis chip on a passive PCI expansion board.

### DETAILED DESCRIPTION

In the following description, reference is made to the accompanying drawings, which form a part hereof and which illustrate the preferred embodiment of the present invention. The drawings and the preferred embodiment of the invention are presented with the understanding that the present invention is susceptible of embodiments in many different forms and, therefore, other embodiments may be utilized and structural and operational changes may be made without departing from the scope of the present invention.

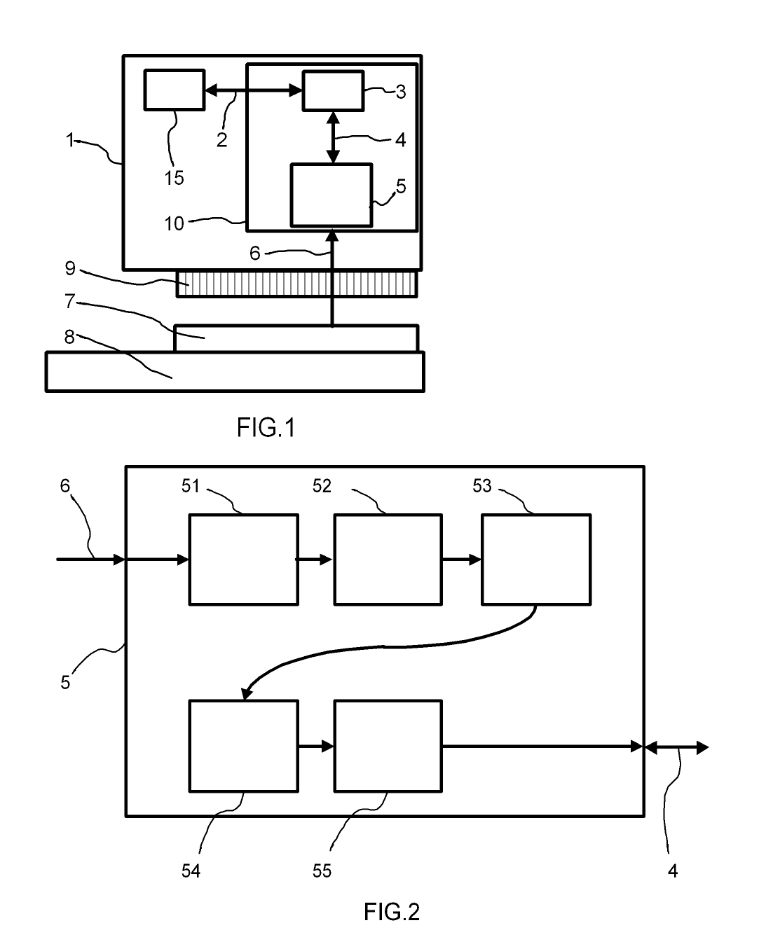

FIG. 1 illustrates a preferred embodiment of the invention as a PCI expansion board (1), also known as an expansion card. The preferred PCI expansion board (1) requires no components other than those physically located on the expansion card. The PCI expansion board (1) monitors use of the computer by the operator, that is, the activity of the computer user in operating the computer. Monitoring includes recording the interactions of the computer user with the computer.

The preferred embodiment of the expansion board has three elements. The first is the pins for engaging in a slot on a motherboard connecting to a data bus that employs a Peripheral Component Interconnect protocol. The second is an electronic circuit capable of receiving, filtering, translating, and controlling storage of data visible to the data bus and received through the pins. And, the third is memory for storing the translated data.

The preferred PCI expansion board (1) operates passively, that is, once installed on the motherboard (8) of a computer, the PCI expansion board (1) is capable of only receiving data from the computer and not sending data to the computer. The data flow (6) would be in one direction from the computer (8) to the PCI expansion board (1). A passive PCI expansion board (1) may not be probed by the computer user and thus is very difficult to detect without opening the computer case and examining the installed components.

An alternative embodiment of the PCI expansion board has a capability to operate actively in that visible data flow (6) may be from the computer to the expansion board or from the expansion board to the computer. In this case, the visible data flow (6) would be represented by a double headed arrow indicating a data flow in both directions. An actively operable PCI expansion board would be capable of switching on a full PCI core so that the card could communicate with an operating system running on the computer. Such communication would be useful in applications where access by a computer user was desired to read the contents of the storage medium, without having to open up the case of the computer.

As is typical for expansion cards, the PCI expansion board (1) has pins (9) for engaging in a PCI slot (7) on a motherboard (8) connecting to a data bus that employs a PCI protocol. Any bus that uses the PCI protocol may be used. Typical examples of such a bus are the standard PCI bus used in desktop computers and a PCI compatible bus such as the Mini-PCI bus used in laptop computers.

Visible data flow (6) to the data bus is any computer read or write instruction that originates from a computer peripheral component. This essentially means that any user interaction with the computer is visible if it originates from a computer PS/2 keyboard, a computer PS/2 mouse, a built in RS232 serial port on the motherboard, a built in parallel printer port on the motherboard, or a Peripheral Component Interconnect graphics card, including but not limited to a Peripheral Component Interconnect modem card for internet connectivity, a Peripheral Component Interconnect expansion card adding RS232 serial ports, a Peripheral Component Interconnect expansion card adding Firewire, a Peripheral Component Interconnect expansion card adding a Universal Serial Bus port, a Peripheral Component Interconnect expansion card adding Ethernet connectivity.

An alternative embodiment of the expansion board has logic to generate a virtual PCI clock signal inside the PCI analysis chip (5). This virtual PCI clock signal is generated based on the existing address and data signals that appear on the PCI slot (7) of the motherboard (8). If the electrical PCI clock signal is temporarily switched off in the PCI slot (7), this virtual PCI clock signal within the PCI analysis chip (5) is used to correctly decode the address and data signals that appear on the PCI slot (7).

The PCI expansion board (1) has an electronic circuit (10) capable of receiving, filtering, translating, and controlling storage of data visible to the data bus and received through the pins.

In an alternative embodiment, two functions of the electronic circuit may be separated into two distinct components. These separable components on the electronic circuit are referred to as the PCI analysis chip (5) and the microcontroller (3). When the context so permits, reference to these components herein is a reference to them either as part of an electronic circuit or as separate components on the expansion card. The preferred embodiment combines the PCI analysis chip (5) and the microcontroller (3) into a single electronic circuit such that the microcontroller has within it a Field Programmable Gate Array (FPGA) memory. However, alternative embodiments using the two components separately on the expansion card enable easy procurement and assembly of the separate components on the expansion board.

The PCI analysis chip (5) receives, filters and translates data visible to the data bus. The microcontroller (3) receives and control storages of the translated data. Data communication (4) between the PCI analysis chip (5) and the microcontroller (3) is bi-directional in order to control the rate of translated data transfer and to permit the microcontroller (3) to configure the PCI analysis chip (5) with the correct addresses to monitor so that PCI analysis chip can receive and translate data on the user interactions with the computer.

In operation of an embodiment of the invention, visible data flow (6) is in the form of data/address combinations. These combinations are sent in parallel via a voltage signal over multiple wires and are received by the electronic circuit PCI analysis chip (5) from the data bus through the pins (9) on the expansion board (1). The PCI analysis chip (5) first receives (51) a combination. Then, the PCI analysis chip (5) determines (52) the address, accesses (53) a stored list of valid addresses, and seeks to match the determined address with a valid address. If there is a match, the PCI analysis chip optionally checks (54) the data for its direction, that is, to see whether it is a read or a write. Then, the data and any determined direction (read/write) is sent (55) to the microcontroller (3), typically by a microcontroller pull of the data from the outgoing buffer via data communication (4).

The PCI analysis chip (5) filters then translates the PCI data visible to the PCI bus to a low-speed, data stream that the microcontroller (3) can receive and interpret for storage. Filtering selects data that can then be translated to human-readable format. The PCI analysis chip then sends the translated data to the microcontroller (3).

In an alternative embodiment, the PCI analysis chip (5) is a separable electronic circuit capable of recording and filtering full-speed data passed through the PCI bus to a memory address used to communicate with a computer peripheral component. Examples of such a separable electronic circuit are (1) a Field Programmable Gate Array (FPGA) containing programmable logic components and programmable interconnects, and (2) a Complex Programmable Logic Device, or CPLD.

The microcontroller (3) interprets the translated data and stores it in an appropriate format in computer readable memory (15) on the expansion board (1). Bi-directional communications (2) between the microcontroller and the storage medium is preferred because the microcontroller has capability to both read from, and write to, the storage medium.

The memory (15) is any computer memory capable of being installed on the expansion card (1). Typical examples include both non-volatile memory and battery-backed volatile memory.

Non-volatile memory, also known as non-volatile storage, is and storage method that can retain the stored information even when it is not powered. An example of non-volatile storage is a flash memory chip or hard drive.

Battery-backed volatile memory is a form of random access memory (RAM), meaning that when the computer is shut down, the battery enables the data stored in RAM to be maintained and not lost.

The preferred memory is flash memory that can be read by plugging a USB cable into the card. In this manner, the card functions much like a USB thumb drive. When the jack is connected into the computer via a USB cable, a drive pops up in Windows Explorer, allowing the contents of the memory card to be read.

### EXAMPLE

An example illustrates the function and use of the invention when installed in a computer. When a computer user types a keystroke on a PS/2 keyboard, this generates an interrupt on an internal IRQ (Interrupt Request) line. The PC motherboard responds by reading the contents of the legacy keyboard controller on I/O port 0x60. Although the keyboard controller is not actually attached to the PCI bus, this request to read I/O port 0x60 is visible on the external PCI bus as a read from address 0x0000 0060, with an associated data value mirroring the keystroke that was pressed.

Thus, if a user pressed the key ‘A’ on the keyboard, this would show up on the PCI bus as a read of address 0x0000 0060, with a returned data value of 0x0000 001 E. The PCI analysis chip would perform a filter match on address 0x0000 0060, and insert data value 0x1E into its internal buffer. This internal buffer would be read by an external microcontroller, converted, and the data representing the keystroke would be stored in memory.

Alternatively, if the character ‘X’ was sent out of RS232 port COM1 (I/O address 0x3F8) to an external modem, this would show up on the PCI bus as a write to address 0x0000 03F8, with an associated data value equivalent to the ASCII value of ‘X’, or 0x0000 0058. The PCI analysis chip would perform a filter match on address 0x0000 03F8, and insert data value 0x58 into its internal buffer.

The expansion board as disclosed herein has been tested to work on over 20 models of personal computer motherboards having a data bus that adheres to the PCI protocol.

The disclosure herein is to be considered as an exemplification of the principles of the invention and is not intended to limit the broad aspect of the invention to the embodiments illustrated. Thus, the scope of the invention is determined by the appended claims and their legal equivalents rather than by the examples given.

What is claimed is:

1. An expansion board for a computer comprising, (a) pins for engaging in a slot on a motherboard connecting to a data bus that employs a Peripheral Component Interconnect protocol; (b) a Peripheral Component Interconnect analysis chip capable of receiving, filtering and translating data visible to the data bus and received through the pins; (c) a microcontroller to receive and control storage of translated data; and, (d) memory for storing the translated data.

2. The expansion board of claim 1 wherein the Peripheral Component Interconnect analysis chip and the microcontroller comprise a single electronic circuit.

3. The expansion board of claim 1 further comprising a Peripheral Component Interconnect clock signal generator.

4. The expansion board of claim 1 wherein the Peripheral Component Interconnect analysis chip is capable of recording and filtering full-speed data passed through the data bus to a memory address used to communicate with a computer peripheral component.

5. The expansion board of claim 1 that is passive in that data flow is only from the computer to the expansion board.

6. The expansion board of claim 1 that is active in that data flow is from the computer to the expansion board and from the expansion board to the computer.

7. The expansion board of claim 1 wherein the data bus that employs a Peripheral Component Interconnect protocol is a Mini-PCI bus used in laptop computers and a Peripheral Component Interconnect bus used in desktop computers.

8. The expansion board of claim 1 wherein data visible to the data bus originates from a computer peripheral component selected from a group consisting of a computer PS/2 keyboard, a computer PS/2 mouse, a Peripheral Component Interconnect expansion card, a built in RS232 serial port on the motherboard, and a built in parallel printer port on the motherboard.

9. The expansion board of claim 1 wherein the memory for storing the translated data is selected from a group consisting of non-volatile memory and battery-backed volatile memory.

10. The expansion board of claim 1 further comprising a USB cable jack to permit downloading of the translated data stored in memory.

11. A method of using the expansion board of claim 1 comprising the steps of, (a) receiving data in the Peripheral Component Interconnect analysis chip through the pins of the expansion board; (b) determining an address in the Peripheral Component Interconnect analysis chip from the data received; (c) accessing a stored list of valid addresses on the Peripheral Component Interconnect analysis chip to match the determined address with a valid address; (d) delivering the data to the microcontroller; and, (e) storing the translated data in the memory.

12. The method of claim 11 further comprising the step of generating a virtual Peripheral Component Interconnect clock signal within the Peripheral Component Interconnect analysis chip.

13. The method of claim 11 further comprising the step of checking the data for its direction in the Peripheral Component Interconnect analysis chip.

14. The method of claim 11 further comprising the step of sending a command to the expansion board to communicate with a host operating system running on the computer to enable a computer user to read the translated data in the memory.
